(19) United States
(12) Patent Application Publication
(10) Pub. No.: US 2007/0234547 A1
(43) Pub. Date: Oct. 11, 2007

(54) SELF-PIERCING PIN AND METHOD OF INSTALLATION

(75) Inventors: Victor A. Lanni, Ray Township, MI (US); Paul Purdy, Holly, MI (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: ACUMENT INTELLECTUAL PROPERTIES, LLC, Troy, MI (US)

(21) Appl. No.: 11/733,371

(22) Filed: Apr. 10, 2007

Related U.S. Application Data
(60) Provisional application No. 60/744,622, filed on Apr. 11, 2006.

(51) Int. Cl. B23P 11/00

(52) U.S. Cl. 29/432; 29/432.1; 29/432.2

(57) ABSTRACT

A self-piercing pin and method of installing same. The pin includes a body portion, a pierce ring, a flange, and a lock groove which is disposed between the pierce ring and the flange. An angled surface is provided between the pierce ring and the lock groove. A top side of the flange is generally flat so that the flange can be set flush to the workpiece, and to enhance the side load strength of the pin once the pin is installed. A bottom side of the flange is beveled, angled or flat, thereby minimizing the amount of workpiece material which becomes displaced during installation. Upon installation, the pierce ring shears the workpiece, and the material of workpiece flows to the lock groove portion of the pin, thereby forming a mechanical lock between the pin and the workpiece. A driver and a die are used to install the pin.

### RELATED APPLICATION (PRIORITY CLAIM)

This application claims the benefit of U.S. Provisional Application Ser. No. 60/744,622, filed Apr. 11, 2006, which is hereby incorporated herein by reference in its entirety.

### BACKGROUND

The present invention generally relates to pins and method of installing pins in a workpiece, and more specifically relates to a self-piercing pin and method of installation.

There are many applications which provide that a pin is to be mounted on a workpiece. One such application is in the automobile industry where a guide pin is used to locate a control arm alignment cam on a vehicle suspension. In a typical installation procedure, a bracket is provided in its flat state, and a hole is punched in the bracket. Then, the guide pin is installed in the hole, and the bracket is formed and welded to the vehicle frame.

While it would be advantageous to be able to decide where exactly to install the pin on the bracket after the bracket is formed and welded to the vehicle frame, in order to more accurately control the pins location relative to the frame's datum, current pins and installation procedures will not allow this. Current pins and installation procedures require that the pin be installed from the back side of workpiece. Consequently, there must be substantial access to the back side of the bracket to install the pin. Because there is such limited space and access to the back side of the bracket once the bracket is formed and welded to the vehicle frame, current pins and installation procedures require that the pin be installed on the bracket before the bracket is formed and welded onto the vehicle frame. Additionally, typical pin designs used for such applications do not provide that they are self-piercing, meaning that a hole must be pre-punched in the workpiece (i.e., the bracket) before the pin is installed.

### OBJECTS AND SUMMARY

An object of an embodiment of the present invention is to provide a self-piercing pin.

Another object of an embodiment of the present invention is to provide a method of installing a self-piercing pin in a workpiece.

Briefly, and in accordance with at least one of the foregoing objects, an embodiment of the present invention provides a self-piercing pin and method of installing such a pin. The pin includes a top, extending (i.e., body) portion and at the opposite end of the pin is a pierce ring which is configured to pierce a workpiece. The pierce ring has a relatively sharp cutting edge and is relatively short. The pin also includes a flange and a lock groove which is disposed between the pierce ring and the flange. The length of the lock groove generally depends on the thickness of the workpiece in which the pin is to be installed. An angled surface is provided between the pierce ring and the lock groove. This not only functions to support the pierce ring during pin installation, but also allows segmented tooling to be used to make the pin. Preferably, a top side of the flange is generally flat so that the flange can be set flush to the workpiece. The fact that the top side of the flange is flat also functions to enhance the lateral strength of the pin once the pin is installed in the workpiece. Preferably, a bottom side of the flange is beveled or angled (or possibly flat), thereby minimizing the amount of workpiece material which becomes displaced during installation of the pin. The bottom side of the flange may also include anti-rotation ribs which generally prevent the pin from rotating relative to the workpiece, both during installation and after the pin is fully installed.

The pin, which may include a threaded or unthreaded extending portion, is configured such that it is self-piercing and can be pierced into a workpiece from the front side, without having to provide a pre-formed hole in the workpiece. As such, in the case of the application where the pin is going to be used to locate a control arm alignment cam on the vehicle suspension, the pin can be installed on the bracket, from the front side, after the bracket is formed and welded onto the vehicle frame. As a result, the pin's location relative to the frame's datum can be more accurately controlled.

Upon installation, the pierce ring shears the workpiece, and the material of workpiece flows to the lock groove portion of the pin, thereby forming a mechanical lock between the pin and the workpiece. Once the pin is installed, preferably both the pierce ring and the top side of the flange are flush against the workpiece.

A driver and a die are used to install the pin, and the die may include a squeeze ring portion which provides that the die can be used in association with a wide range of workpiece thicknesses. The lock groove of the pin can be provided as being: wider than the extending portion of the pin; the same width as the extending portion of the pin; or narrower than the extending portion of the pin. If the lock groove is the same width as the extending portion of the pin, a top of the pin can be provided as being collapsible during installation. If the lock groove is narrower than the extending portion of the pin, a driver which includes a spring-loaded ram can be used to install the pin.

### BRIEF DESCRIPTION OF THE DRAWINGS

The organization and manner of the structure and operation of the invention, together with further objects and advantages thereof, may best be understood by reference to the following description, taken in connection with the accompanying drawing, wherein:

FIG. 1 is a side view of a self-piercing pin which is in accordance with an embodiment of the present invention;

FIG. 2 is an enlarged view of a portion of the self-piercing pin shown in FIG. 1;

FIG. 3 is a cross-sectional view of a die which can be used to install the self-piercing pin shown in FIG. 1;

FIGS. 4-9 are sequence views which show the pin of FIG. 1 being installed in a workpiece;

FIG. 10 shows the situation where a lock groove portion of the pin is wider than a body portion of the pin, in which case only a flange of the pin is engaged by the driver;

FIG. 11 shows the situation where the lock groove portion of the pin is narrower than the body portion of the pin, in which case a driver having a spring-loaded ram can be used to install the pin; and

FIGS. 12 and 13 are side views of self-piercing elements which are in accordance with alternative embodiments of the present invention.

### DESCRIPTION

While the invention may be susceptible to embodiment in different forms, there are shown in the drawings, and herein will be described in detail, specific embodiments of the invention. The present disclosure is to be considered an example of the principles of the invention, and is not intended to limit the invention to that which is illustrated and described herein.

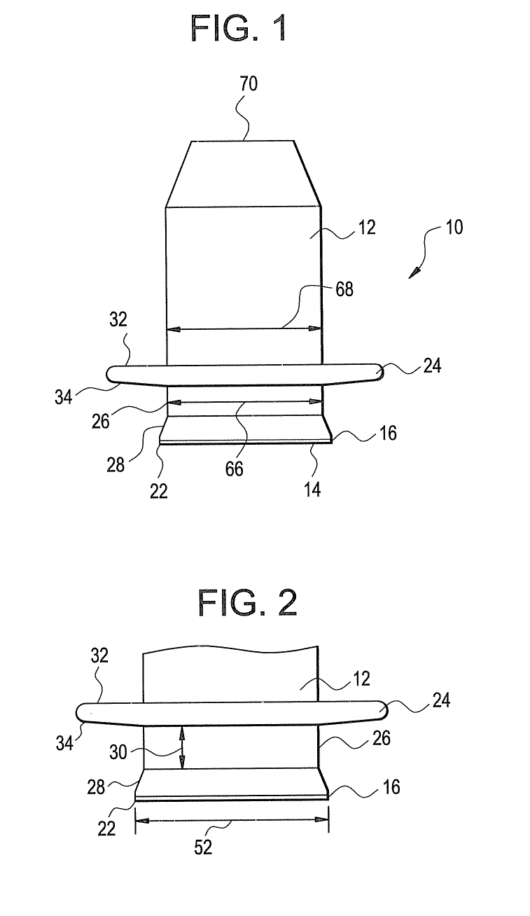

FIG. 1 shows a pin 10 which is in accordance with an embodiment of the present invention. The pin 10 is configured such that it is self-piercing and can be pierced into a workpiece from the front side, without a pre-formed hole having to be provided in the workpiece. While the pin 10 may be used in applications other than the automobile industry and in applications other than that which was described hereinabove in the background section, in the case of the application where the pin 10 is going to be used to locate a control arm alignment cam on a vehicle suspension, the pin 10 can be installed on the bracket, from the front side of the bracket, after the bracket is formed and welded onto the vehicle frame. As a result, the pin's location relative to the frame's datum can be more accurately controlled.

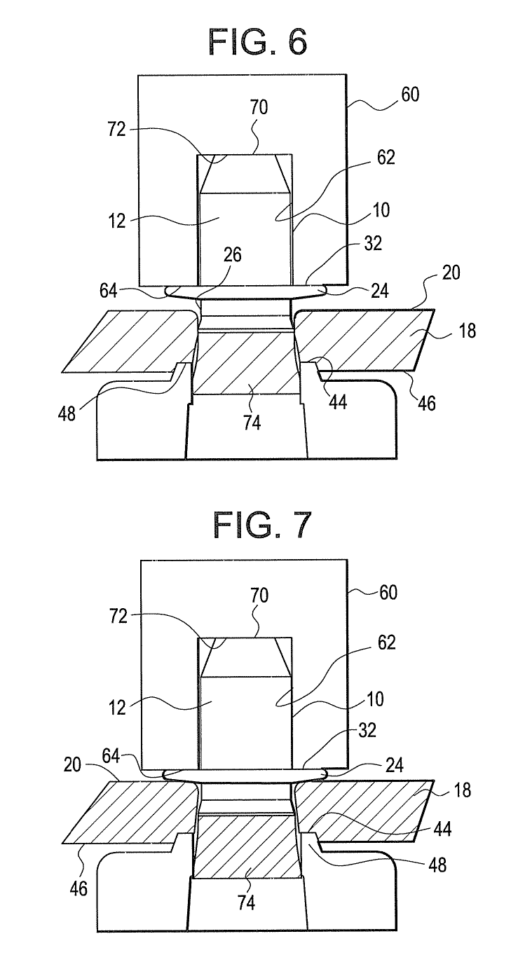

As shown in FIG. 1, the pin 10 includes a top, extending portion (hereinafter “body portion”) 12 which can be threaded or unthreaded, and at the opposite end 14 of the pin 10 is a piercing surface such as a pierce ring 16 which is configured to pierce a workpiece 18 (see FIGS. 4-9), from its front side 20, upon installation. The pierce ring 16 has a relatively sharp cutting edge 22 and is preferably relatively short. The pierce ring 16 is provided as being solid, thereby providing for the ability to pierce thicker workpieces, and increasing the force needed to push the pin 10 out of the workpiece 18 after the pin 10 is installed.

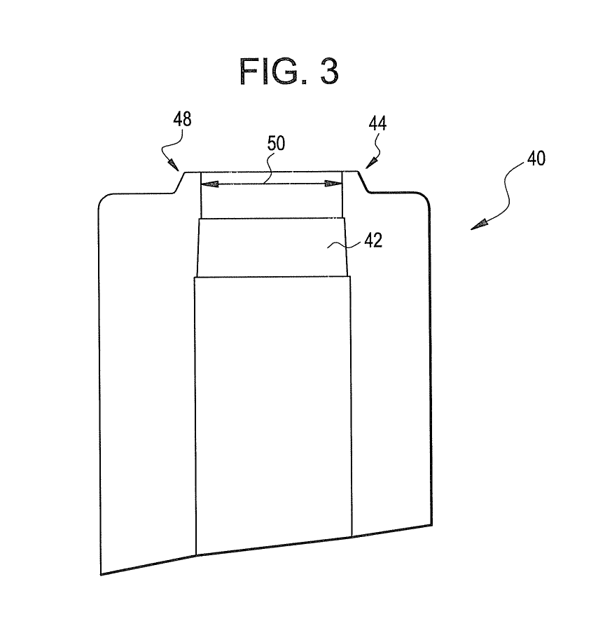

The pin 10 also includes a flange 24 and a lock groove 26 which is disposed between the pierce ring 16 and the flange 24. FIG. 2 provides an enlarged view of the portion of the pin 10 which includes the pierce ring 16, the lock groove 26, the flange 24, and an angled surface 28 which is provided between the pierce ring 16 and the lock groove 26. The angled surface 28 not only functions to support the pierce ring 16 during pin installation, but also allows segmented tooling to be used to make the pin 10. The length of the lock groove 26 (dimension 30 in FIG. 2) will generally depend on the thickness of the workpiece in which the pin 10 is to be installed.

The flange 24 not only functions to displace workpiece material during installation of the pin 10, but also to increase the side load strength of the pin 10 after the pin 10 is installed. Preferably, a top side 32 of the flange 24 is generally flat so that the flange 24 can be set flush to the workpiece 18. The fact that the top side 32 of the flange 24 is wider than the body also functions to enhance the side load strength of the pin 10 once the pin 10 is installed in the workpiece 18. Preferably, a bottom side 34 of the flange 24 is beveled or angled (or possibly flat), thereby minimizing the amount of workpiece material which becomes displaced during installation of the pin 10, as well as aiding in the manufacturing of the pin 10 (i.e., with regard to being able to use segmented tooling to make the pin 10). The bottom side 34 of the flange 24 may also include anti-rotation ribs thereon, which generally prevent the pin 10 from rotating relative to the workpiece 18 during installation of the pin 10 and after the pin 10 is installed.

The lock groove 26 is configured such that the workpiece material which is displaced by the flange 24 during installation of the pin 10 will have a place to go, thereby forming a mechanical lock with the pin 10. As discussed above, the length 30 of the lock groove 26 can be lengthened or shortened, depending on the thickness of the workpiece in which the pin is to be installed.

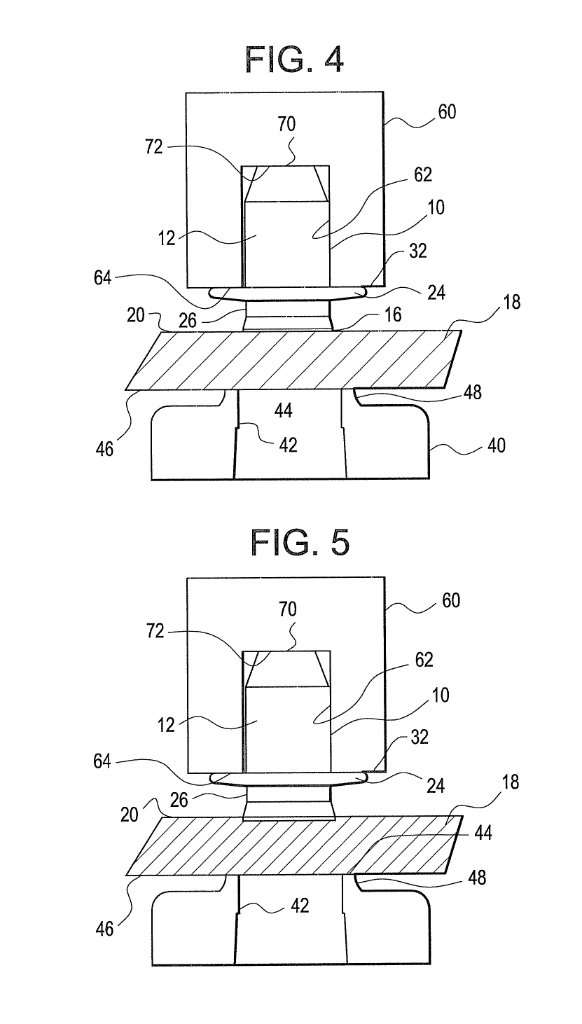

FIG. 3 is a cross-sectional view of a die 40 which can be used to install the pin 10. As shown, preferably the die 40 includes a longitudinal bore 42. The die 40 includes a bearing surface 44 which bears against the back side 46 of the workpiece 18 during installation of the pin 10. As shown, the bearing surface 44 may include a raised surface or squeeze ring 48, which effectively functions to allow the die 40 to be used in association with a wide range of workpiece thicknesses. Alternatively, the die 40 may be provided as having a flat bearing surface 44 (i.e., with no squeeze ring 48). If a squeeze ring 48 is provided, the squeeze ring 48 may be provided as having the same shape but different dimensions for height and inner diameter to accommodate different panel thicknesses. The squeeze ring 48, if provided, effectively serves two purposes:
1. To provide a lower cutting surface for the pierce ring 16. This is accomplished by adjusting the inner diameter 50 (identified in FIG. 3) of the squeeze ring 48. The difference in size between the inner diameter 50 of the squeeze ring 48 and the width of the pierce ring 16 (dimension 52 in FIG. 2) is called the “the punch clearance”. The punch clearance should be between 10% and 28% depending on material type and thickness.
2. To extend into the workpiece material toward the pierce ring 16.

This provides the ability to use one pin design for different workpiece thicknesses.

FIGS. 4-9 are sequence views which show the pin 10 being installed in a workpiece 18. As shown, not only is the die 40 used to install the pin 10, but a driver 60 is also used. Specifically, while the die 40 engages the back side 46 of the workpiece 18, the driver 60 engages the pin 10. The driver 60 includes a circular bore 62 which receives the body portion 12 of the pin 10, and a bearing surface 64 which contacts the top side 32 of the flange 24.

Additionally, in the case where the lock groove 26 is the same width as or smaller than the body portion 12 of the pin 10 (i.e., dimension 66 is the same size as or smaller than dimension 68 in FIG. 1), during installation of the pin 10, preferably the driver 60 not only pushes on a top surface 32 of the flange 24, but an internal surface 72 of the driver 60 engages a tip 70 of the pin 10, and preferably the tip 70 of the pin 10 is configured such that it collapses during installation. More specifically, preferably the tip 70 of the pin 10 is configured such that it collapses under a pre-determined force, said force being greater than that required for the pierce ring 16 to pierce the workpiece 18, but less than the force needed to shear the flange 24 of the pin 10.

As shown in FIG. 4, during installation of the pin 10, the driver 60 holds the pin 10 in position, generally aligned with the die 40 which is on the other side 46 of the workpiece 18. Then, as shown in FIG. 5, the driver 60 pushes on the pin 10 (more specifically, the bearing surface 64 of the driver 60 pushes on the top surface 32 of the flange 24 and the internal surface 72 of the driver 60 pushes on the tip 70 of the pin 10), causing the pierce ring 16 to begin to pierce into the workpiece 18 and the squeeze ring 48 (if provided) of the die 40 to begin to pierce into the other side 46 of the workpiece 18. As shown in FIGS. 6 and 7, as the driver 60 continues to push on the pin 10, the pierce ring 16 shears a slug 74 out of the workpiece 18, and the bottom side 34 of the flange 24 (as well as the squeeze ring 48 of the die 40, if provided, as shown in FIGS. 4-9) imbeds into the workpiece 18, causing workpiece material to flow toward the lock groove 26 and create a mechanical lock between the pin 10 and the workpiece 18. As shown in FIG. 8, eventually the pierce ring 16 shears the slug 74 completely out of the workpiece 18, and the slug 74 drops into the die 40. Once the slug 74 is fully sheared from the workpiece 18, into the die 40, and the pin 10 has been pushed into the workpiece sufficiently such that the top side 32 of the flange 24 becomes flush with the workpiece 18, the driver 60 and die 40 can be withdrawn from the pin 10 and workpiece 18, respectively, as shown in FIG. 9, at which time the pin 10 is fully installed. At this time, not only is the top surface 32 of the flange 24 flush with the front side 20 of the workpiece 18, but preferably the pierce ring 16 also does not protrude much, if at all, from the back side 46 of the workpiece 18.

As described, the pin 10 is configured such that it is self-piercing and can be pierced into a workpiece 18 from the front side 20, without there being a pre-formed hole being provided in the workpiece 18. While the pin 10 may be used in applications other than the automobile industry and in applications other than that which was described hereinabove in the background section, in the case of the application where the pin 10 is going to be used to locate a control arm alignment cam on the vehicle suspension, the pin 10 can be installed on the bracket after the bracket is formed and welded onto the vehicle frame. As a result, the pin's location relative to the frame's datum can be more accurately controlled.

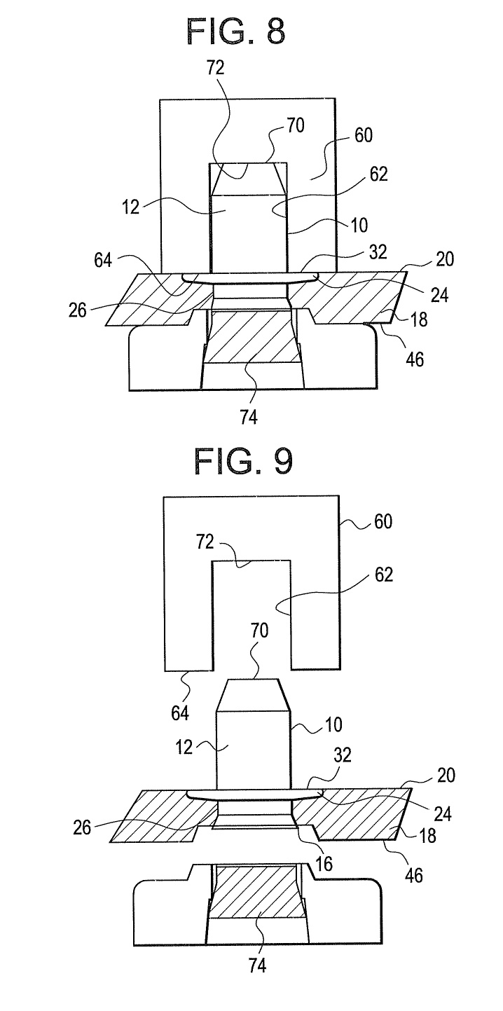

As described above, the length 30 of the lock groove 26 can be varied depending on the thickness of the workpiece in which the pin 10 is to be installed. Additionally, the width 66 of the lock groove 26 can also be varied. FIGS. 1, 2 and 4-9 show the situation where the lock groove 26 is the same width as the body portion 12 of the pin 10. In the case where the lock groove portion 26 of the pin is provided as being wider than the body portion 12 of the pin 10, as shown in FIG. 10, the driver 60 may be configured such that it only engages the flange 24 of the pin 10 and does not engage the tip 70 of the pin 10 during installation.

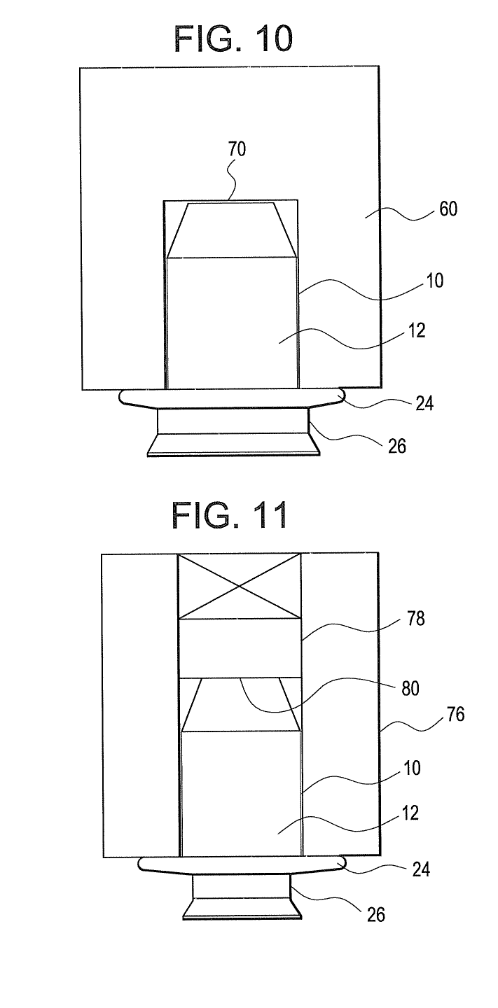

Alternatively, the lock groove portion 26 of the pin 10 can be provided as being narrower than that of the body portion 12 of the pin 10, as shown in FIG. 11. In such case, a driver 76 having an internal, spring-loaded ram 78 can be used, wherein during installation, the driver 76 not only pushes on a top surface 32 of the flange 24, but a surface 80 of the spring-loaded rain 78 also pushes on the tip 70 of the pin 10. If a spring-loaded ram 78 is used, preferably the spring-loaded ram 78 is spring loaded such that the ram 78 is configured to collapse under a pre-determined force, said force being greater than that required for the pierce ring 16 to pierce the workpiece 18, but less than the force needed to shear the flange 24 of the pin 10.

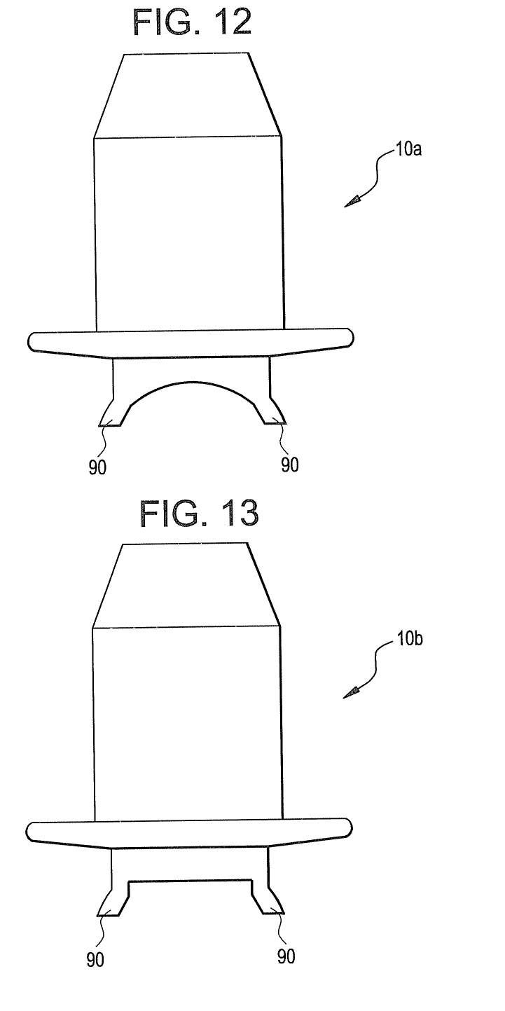

FIGS. 12 and 13 are side views of self-piercing elements 10a, 10b which are in accordance with alternative embodiments of the present invention. As shown, each of these elements 10a, 10b includes legs 90 which are configured to pierce into a workpiece. While these two designs have been found to be cheaper and easier to manufacture than the self-piercing pins 10 illustrated in FIGS. 1, 2 and 4-11, it has been found that the designs illustrated in FIGS. 12 and 13 only work with relatively thin workpieces (i.e., up to 2.5 millimeters thick). However, the general concept and the method of installation would be as described hereinabove with regard to FIGS. 1-11.

While embodiments of the present invention are shown and described, it is envisioned that those skilled in the art may devise various modifications of the present invention without departing from the spirit and scope of the foregoing disclosure.

What is claimed is:

1. A self-piercing pin for piercing and seating in a workpiece, said self-piercing pin comprising: an extending, pin portion proximate one end; a piercing surface proximate an opposite end, wherein the piercing surface is configured to pierce the workpiece; and a flange disposed between the pin portion and the piercing surface, said flange configured to seat on the workpiece when the self-piercing pin is installed.

2. A self-piercing pin as recited in claim 1, wherein the piercing surface comprises a pierce ring having a cutting edge.

3. A self-piercing pin as recited in claim 2, further comprising a lock groove which is disposed between the pierce ring and the flange.

4. A self-piercing pin as recited in claim 3, further comprising an angled surface which is disposed between the pierce ring and the lock groove.

5. A self-piercing pin as recited in claim 2, wherein a top side of the flange is generally flat, thereby providing that the flange is settable flush to the workpiece.

6. A self-piercing pin as recited in claim 2, wherein a bottom side of the flange is angled.

7. A self-piercing pin as recited in claim 2, wherein said self-piercing pin is configured such that the self-piercing pin is pierceable into the workpiece from a front side of the workpiece, without having to provide a pre-formed hole in the workpiece.

8. A self-piercing pin as recited in claim 3, wherein said self-piercing pin is configured such that upon installation, the pierce ring shears the workpiece, and material of workpiece flows to the lock groove of the self-piercing pin, thereby forming a mechanical lock between the self-piercing pin and the workpiece.

9. A self-piercing pin as recited in claim 3, wherein the lock groove is the same width as the extending, pin portion.

10. A self-piercing pin as recited in claim 3, wherein the lock groove is wider than the extending, pin portion.

11. A self-piercing pin as recited in claim 3, wherein the lock groove is narrower than the extending, pin portion.

12. A self-piercing pin as recited in claim 1, wherein the piercing surface comprises legs.

13. A method of installing a self-piercing in a workpiece, said method comprising pushing the self-piercing pin through the workpiece, wherein a pierce ring of the self-piercing pin shears the workpiece and a flange of the self-piercing pin seats on the workpiece, with an extending, pin portion of the self-piercing pin extending from the flange.

14. A method as recited in claim 13, further comprising engaging a driver with a surface of the flange and using the driver to push on the flange causing the pierce ring to pierce the workpiece.

15. A method as recited in claim 13, further comprising engaging a driver with a surface of the flange and a tip of the extending, pin portion, and using the driver to push on the flange and the tip on the extending, pin portion, causing the pierce ring to pierce the workpiece.

16. A method as recited in claim 14, further comprising engaging a die with the workpiece while using the driver to push on the flange of the self-piercing pin.

17. A method as recited in claim 14, further comprising engaging a squeeze ring of a die with the workpiece while using the driver to push on the flange of the self-piercing pin.

18. A method as recited in claim 14, wherein the step of engaging a driver with a surface of the flange and using the driver to push on the flange causing the pierce ring to pierce the workpiece comprises using a driver which comprises an internal, spring loaded ram.

19. A method as recited in claim 13, further comprising causing both the pierce ring and a top side of the flange to be flush against the workpiece upon installation of the self-piercing pin.

20. A method as recited in claim 13, wherein the step of pushing the self-piercing pin through the workpiece comprises using the self-piercing pin to pierce into the workpiece from a front side of the workpiece, without providing a pre-formed hole in the workpiece.
